(19) United States
(12) Patent Application Publication
(10) Pub. No.: US 2014/0173471 A1
(43) Pub. Date: Jun. 19, 2014

(54) METHOD, APPARATUS, AND COMPUTER PROGRAM PRODUCT FOR A CURVED USER INTERFACE

(71) Applicant: NOKIA CORPORATION, Espoo (FI)

(72) Inventor: Jani Maenpaa, Espoo (FI)

(73) Assignee: NOKIA CORPORATION, Espoo (FI)

(21) Appl. No.: 13/719,769

(22) Filed: Dec. 19, 2012

(51) Int. Cl. G06F 3/0484

(52) U.S. Cl. CPC G06F 3/0484
USPC 715/763

(57) ABSTRACT

A method, apparatus and computer program product is provided for displaying user interface objects on a curved display. As a result of a movement of an object in a curved area of a display, the object may change speed or shape based on a virtual effect of gravity. As such, the objects may display inertia, and change more or less drastically depending on a steepness of a curve of the display. Uses for the gravitational effects include gaming, realistic screen savers, and/or other displays of visual content.

### TECHNOLOGICAL FIELD

An example embodiment of the present invention relates generally to device displays, and more particularly, to a method, apparatus and computer program product for displaying user interface objects on a curved display.

### BACKGROUND

The widespread use of technology in everyday life has led to an increased demand for improved visual effects. In some areas, such as gaming, there exists an even larger demand for realistic visual effects. New devices including those with curved displays may make games and virtual environments more realistic. However, improvements in the visual effects that are displayed upon such curved displays cause games and virtual environments to be even more realistic.

### BRIEF SUMMARY

A method, apparatus, and computer program product are therefore provided for creating gravitational effects on user interface objects so as to make the user interface objects and the movement of such user interface objects even more realistic. A method is provided including receiving an indication of a movement of a user interface object in a curved area of a display and causing the shape of the user interface object to change based on the position of the object in the curved area of the display. The method of one embodiment also includes causing the speed of the user interface object to change based on the position of the object in the curved area of the display. The user interface object may display an inertial property and a change to the user interface object may be based on a virtual effect of gravity. In some embodiments, the user interface object may be an object in a game or a screen saver. The movement of the user interface object may occur automatically, or may be caused by a user navigation. In some embodiments, a change to the user interface object is intensified as the user interface object moves into a more steeply curved area of the display, relative to a change of the user interface object in a flatter area of the display.

In some embodiments, an apparatus is provided, including at least one processor and at least one memory including computer program code, the at least one memory and the computer program code configured to, with the processor, cause the apparatus to at least receive an indication of a movement of a user interface object in a curved area of a display and cause the shape of the user interface object to change based on the position of the object in the curved area of the display. In some embodiments, the memory and computer program code may be configured to cause the speed of the user interface object to change based on the position of the object in the curved area of the display. The user interface object may display an inertial property and a change to the user interface object may be based on a virtual effect of gravity. In some embodiments, the user interface object may be an object in a game or a screen saver. The movement of the user interface object may occur automatically, or may be caused by a user navigation. In some embodiments, a change to the user interface object is intensified as the user interface object moves into a more steeply curved area of the display, relative to a change of the user interface object in a flatter area of the display.

In some embodiments, a computer program product is provided, including at least one non-transitory computer-readable storage medium having computer-executable program code instructions stored therein, the computer-executable program code instructions comprising program code instructions to cause the apparatus to at least receive an indication of a movement of a user interface object in a curved area of a display and cause the shape of the user interface object to change based on the position of the object in the curved area of the display. In some embodiments, the program code instructions may be configured to cause the speed of the user interface object to change based on the position of the object in the curved area of the display. The user interface object may display an inertial property and a change to the user interface object may be based on a virtual effect of gravity. In some embodiments, the user interface object may be an object in a game or a screen saver. The movement of the user interface object may occur automatically, or may be caused by a user navigation. In some embodiments, a change to the user interface object is intensified as the user interface object moves into a more steeply curved area of the display, relative to a change of the user interface object in a flatter area of the display.

In some embodiments, an apparatus is provided, with means for receiving an indication of a movement of a user interface object in a curved area of a display and causing the shape of the user interface object to change based on the position of the object in the curved area of the display. In some embodiments, the apparatus may include means to cause the speed of the user interface object to change based on the position of the object in the curved area of the display. The user interface object may display an inertial property and a change to the user interface object may be based on a virtual effect of gravity. In some embodiments, the user interface object may be an object in a game or a screen saver. The movement of the user interface object may be caused by a user navigation. In some embodiments, a change to the user interface object is intensified as the user interface object moves into a more steeply curved area of the display, relative to a change of the user interface object in a flatter area of the display.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of a gravitational effects recognition apparatus that may be configured to implement example embodiments of the present invention;

FIG. 2 is a flowchart illustrating operations to create gravitational effects using a gravitational effects apparatus in accordance with one embodiment of the present invention;

FIG. 3A is a view of a curved display from the side, and FIG. 3B is a view of a curved display from above, according to some example embodiments;

FIGS. 4A and 4B are example displays according to some example embodiments; and

FIG. 5A is a view of a curved display from the side, FIG. 5B is a view of a curved display from above, and FIGS. 5C and 5D are views of a curved display according to some example embodiments.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

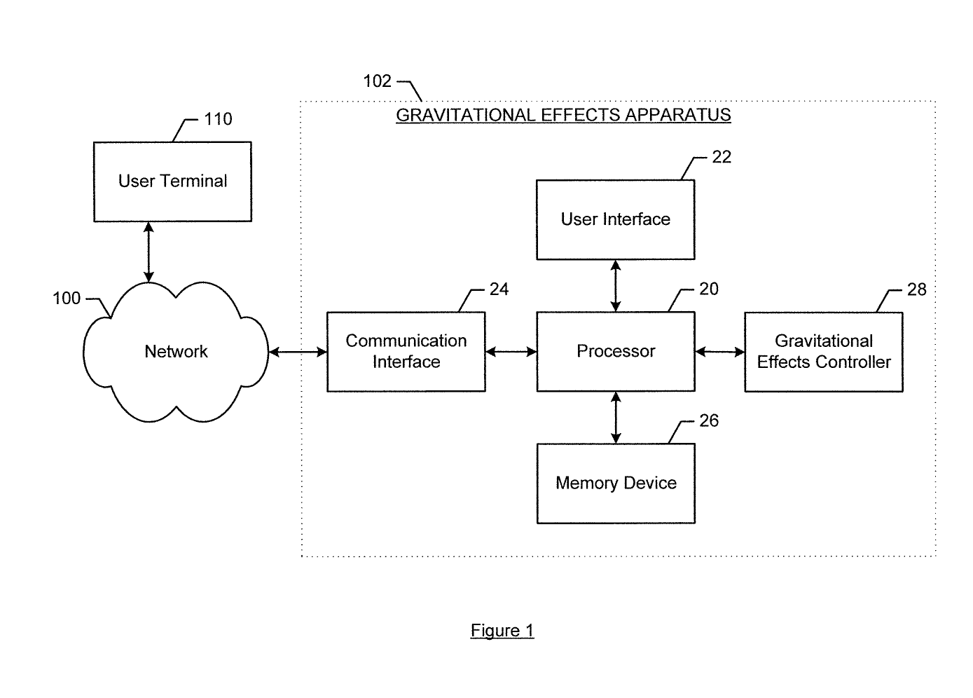

As described below, a method, apparatus and computer program product are provided for creating gravitation effects on a user interface object. Referring to FIG. 1, gravitational effects apparatus 102 may include or otherwise be in communication with processor 20, user interface 22, communication interface 24, memory device 26, and gravitational effects controller 28. Gravitational effects apparatus 102 may be embodied by a wide variety of devices including mobile terminals, e.g., mobile telephones, smartphones, tablet computers, laptop computers, or the like, computers, workstations, servers or the like and may be implemented as a distributed system or a cloud based entity.

In some embodiments, the processor 20 (and/or co-processors or any other processing circuitry assisting or otherwise associated with the processor 20) may be in communication with the memory device 26 via a bus for passing information among components of the gravitational effects apparatus 102. The memory device 26 may be non-transitory, and may include, for example, one or more volatile and/or non-volatile memories. In other words, for example, the memory device 26 may be an electronic storage device (e.g., a computer readable storage medium) comprising gates configured to store data (e.g., bits) that may be retrievable by a machine (e.g., a computing device like the processor 20). The memory device 26 may be configured to store information, data, content, applications, instructions, or the like for enabling the apparatus to carry out various functions in accordance with an example embodiment of the present invention. For example, the memory device 26 could be configured to buffer input data for processing by the processor 20. Additionally or alternatively, the memory device 26 could be configured to store instructions for execution by the processor 20.

The gravitational effects apparatus 102 may, in some embodiments, be embodied in various devices as described above. However, in some embodiments, the gravitational effects apparatus 102 may be embodied as a chip or chip set. In other words, the gravitational effects apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The gravitational effects apparatus 102 may therefore, in some cases, be configured to implement an embodiment of the present invention on a single chip or as a single “system on a chip.” As such, in some cases, a chip or chipset may constitute means for performing one or more operations for providing the functionalities described herein.

The processor 20 may be embodied in a number of different ways. For example, the processor 20 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 20 may include one or more processing cores configured to perform independently. A multi-core processor may enable multiprocessing within a single physical package. Additionally or alternatively, the processor 20 may include one or more processors configured in tandem via the bus to enable independent execution of instructions, pipelining and/or multithreading.

In an example embodiment, the processor 20 may be configured to execute instructions stored in the memory device 26 or otherwise accessible to the processor 20. Alternatively or additionally, the processor 20 may be configured to execute hard coded functionality. As such, whether configured by hardware or software methods, or by a combination thereof, the processor 20 may represent an entity (e.g., physically embodied in circuitry) capable of performing operations according to an embodiment of the present invention while configured accordingly. Thus, for example, when the processor 20 is embodied as an ASIC, FPGA or the like, the processor 20 may be specifically configured hardware for conducting the operations described herein. Alternatively, as another example, when the processor 20 is embodied as an executor of software instructions, the instructions may specifically configure the processor 20 to perform the algorithms and/or operations described herein when the instructions are executed. However, in some cases, the processor 20 may be a processor of a specific device (e.g., a mobile terminal or network entity) configured to employ an embodiment of the present invention by further configuration of the processor 20 by instructions for performing the algorithms and/or operations described herein. The processor 20 may include, among other things, a clock, an arithmetic logic unit (ALU) and logic gates configured to support operation of the processor 20.

Meanwhile, the communication interface 24 may be any means such as a device or circuitry embodied in either hardware or a combination of hardware and software that is configured to receive and/or transmit data from/to a network and/or any other device or module in communication with the gravitational effects apparatus 102. In this regard, the communication interface 24 may include, for example, an antenna (or multiple antennas) and supporting hardware and/or software for enabling communications with a wireless communication network. Additionally or alternatively, the communication interface 24 may include the circuitry for interacting with the antenna(s) to cause transmission of signals via the antenna(s) or to handle receipt of signals received via the antenna(s). In some environments, the communication interface 24 may alternatively or also support wired communication. As such, for example, the communication interface 24 may include a communication modem and/or other hardware/software for supporting communication via cable, digital subscriber line (DSL), universal serial bus (USB) or other mechanisms.

In some embodiments, such as instances in which the gravitational effects apparatus 102 is embodied by a user device, the gravitational effects apparatus 102 may include a user interface 22 that may, in turn, be in communication with the processor 20 to receive an indication of a user input and/or to cause provision of an audible, visual, mechanical or other output to the user. As such, the user interface 22 may include, for example, a keyboard, a mouse, a joystick, a display, a touch screen(s), touch areas, soft keys, a microphone, a speaker, or other input/output mechanisms. Alternatively or additionally, the processor 20 may comprise user interface circuitry configured to control at least some functions of one or more user interface elements such as, for example, a speaker, ringer, microphone, display, and/or the like. The processor 20 and/or user interface circuitry comprising the processor 20 may be configured to control one or more functions of one or more user interface elements through computer program instructions (e.g., software and/or firmware) stored on a memory accessible to the processor 20 (e.g., memory device 26, and/or the like).

In some example embodiments, processor 20 may be embodied as, include, or otherwise control a gravitational effects controller 28 for providing gravitational effects on user interface objects. As such, the gravitational effects controller 28 may be embodied as various means, such as circuitry, hardware, a computer program product comprising computer readable program instructions stored on a computer readable medium (for example, memory device 26) and executed by a processing device (for example, processor 20), or some combination thereof. Gravitational effects controller 28 may be capable of communication with one or more of the processor 20, memory device 26, user interface 22, and communication interface 24 to access, receive, and/or send data as may be needed to perform one or more of the gravitational effects functionalities as described herein

Any number of user terminal(s) 110 may connect to gravitational effects apparatus 102 via a network 100. User terminal 110 may be embodied as a mobile terminal, such as personal digital assistants (PDAs), pagers, mobile televisions, mobile telephones, gaming devices, laptop computers, tablet computers, cameras, camera phones, video recorders, audio/video players, radios, global positioning system (GPS) devices, navigation devices, or any combination of the aforementioned. The user terminal 110 need not necessarily be embodied by a mobile device and, instead, may be embodied in a fixed device, such as a computer, workstation. User terminal(s) 110 may include a curved display, may be a touch screen, display screen, Liquid Crystal Display (LCD) or a combination, and in some embodiments, the entire user terminal 110 may be curved. In some embodiments, the curved display of user terminal 110 may actually comprise multiple displays, but for simplicity will be referred to as a single display hereinafter.

Network 100 may be embodied in a local area network, the Internet, any other form of a network, or in any combination thereof, including proprietary private and semi-private networks and public networks. The network 100 may comprise a wire line network, wireless network (e.g., a cellular network, wireless local area network, wireless wide area network, some combination thereof, or the like), or a combination thereof, and in some example embodiments comprises at least a portion of the Internet. As another example, a user terminal 110 may be directly coupled to or may include a gravitational effects apparatus 102.

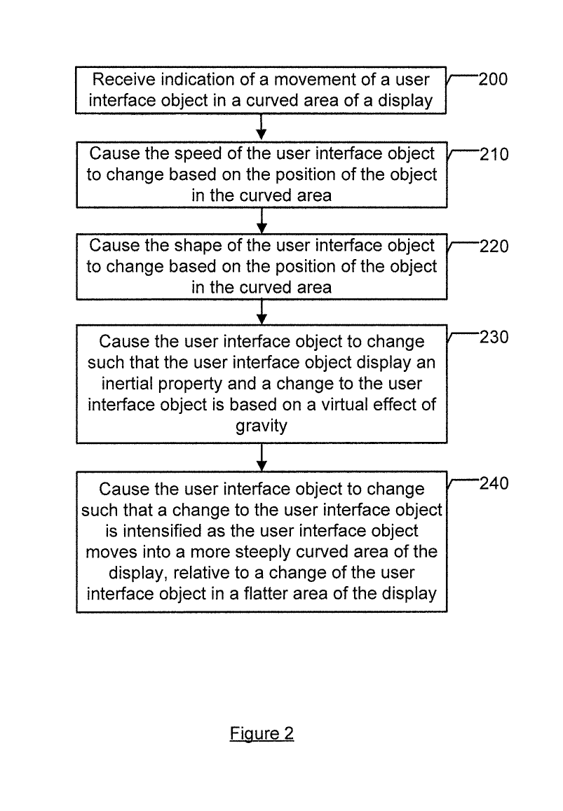

Referring now to FIG. 2, the operations for providing gravitational effects on user interface objects are outlined in accordance with one example embodiment. At operation 200, gravitational effects apparatus 102 may include means, such as communication interface 24, processor 20, gravitation effects controller 28, or the like, for receiving an indication of a movement of a user interface object in a curved area of a display of user terminal 110. The user interface object may be any object visible on the display screen, such as a shape, an icon representing a file, an application, or other entity, a marker in a game, or any other visual content on a display. The indication of a movement may be detected automatically, by a processor 20, for example, or it may be received in conjunction with a user-initiated navigation, such as with a pointing device, for example. In this regard, a user may drag and drop a user interface item from a flat area of a display to a curved area of a display with the movement of the user interface item causing an indication of movement to be provided.

The user interface object may move across a display. For example, continuing to operation 210, an in an instance in which the user interface object is moving, gravitational effects apparatus 102 may include means, such as the gravitational effects controller 28, processor 20, communication interface 24, and/or the like, for causing the speed of the user interface object to change based on the position of the object in the curved area. As such, a user interface object moving downwardly in a downward-curved area of a display may move at a faster speed compared to a movement of the user interface item on a flat portion or upward-curved portion of the display, thereby simulating the effect of gravity. Conversely, a user interface object moving in an upward-curved area of a display may move at slower speed compared to a movement on a flat portion or downward-curved portion of the display.

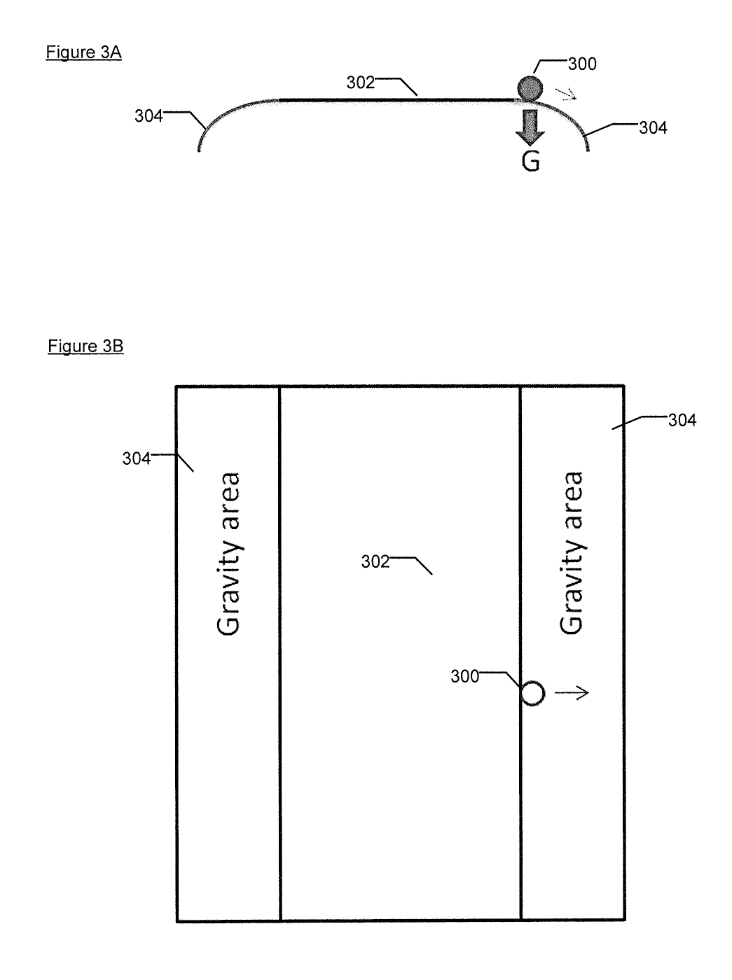

For example, the display of FIG. 3A, viewed from the side, includes a flat area 302 and curved areas 304. In this example embodiment, the curved areas 304 are downward curves, relative to a flat area. A user interface object 300 (shown resting on the display for sake of example) has been moved into a curved area 304. As shown in FIG. 3B, from a view looking down onto a display of a user terminal 110A, the corresponding curved area 304 as seen in FIG. 3A, represents a gravity area. As such, having received an indication of a movement of the user interface object 300 in a downwardly direction in the curved area 304, the gravitational effects apparatus 102 may cause the user interface object 300 to move faster, creating a visual gravitational effect.

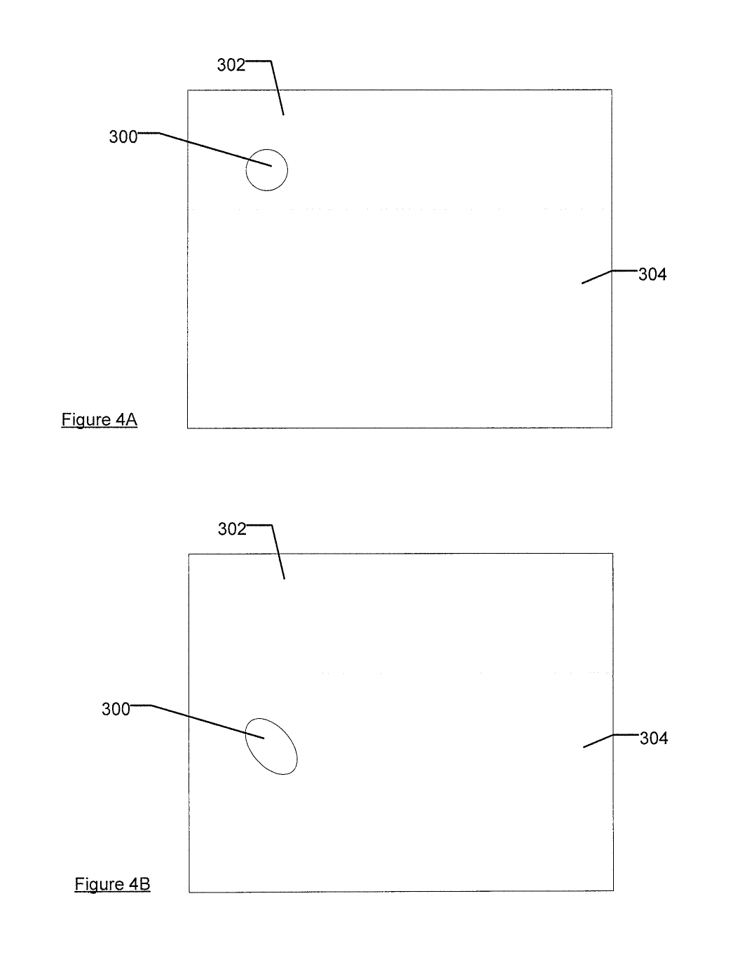

Returning to FIG. 2, at operation 220, gravitational effects apparatus 102 may include means, such as the gravitational effects controller 28, processor 20, communication interface 24, and/or the like, for causing the shape of the user interface object to change based on the position of the object in the curved area. In this regard, the user interface object 300 may be transformed to create the appearance that the user interface object is moving up or down a curve, or in the example displays of FIGS. 4A and 4B, down a waterfall, such as by elongating the user interface object in a direction consistent with gravitational effects. The curve of the display 304, in this example embodiment may represent a waterfall, and the flat area of the display may represent a flat portion of the water. In FIG. 4A, the user interface object 300 is on a flat area of the display, but after moving into the waterfall, or curved area of the display, the user interface object appears elongated, creating a more realistic view of the user interface object 300 from a different viewing angle caused by the curve in the display or waterfall. In some example embodiments, the shape of a user interface object may change to create the appearance of movement up a hill or other upward curve of a display.

Returning to FIG. 2, at operation 230, gravitational effects apparatus 102 may include means, such as the gravitational effects controller 28, processor 20, and/or the like, for causing the user interface object to change such that the user interface object displays an inertial property and a change to the user interface object is based on a virtual effect of gravity. In this regard, a relatively heavy object, such as a bowling ball, may move at a faster speed down a curved area of a display (or slower speed up a curved area), while a relatively lighter object, such as an apple, may move at a slower speed down a curved area of a display.

Similarly, the shape of the object mobility may transform less or more drastically based on an inertial property, such as flexibility or deformability, as it moves into a curved area of a display, and the amount of transformation may be proportional to the flexibility or deformability. For example, a user interface object representing a very solid object, such as a rock, may not change shape at all, or not to the extent of another object displaying more flexibility. For example, an image of an individual riding a raft down a waterfall may include loose clothing or hair blowing or trailing behind a center of mass of the object.

Continuing to operation 240, gravitational effects apparatus 102 may include means, such as the gravitational effects controller 28, processor 20, and/or the like, for causing the user interface object to change such that a change to the user interface object is intensified as the user interface object moves into a more steeply curved area of the display, relative to a change of the user interface object in a flatter area of the display. The changes may intensity or decrease proportionally to the steepness of a curve. For example, a user interface object representing a ball rolling down a hill may accelerate as it continues into a steeper area of the curve. A user interface object representing a malleable object or one with loose parts, may transform shape more drastically in a steeper area of a downward curve, compared to a change in shape of the user interface object in a flatter area of or more gradual curve. A user interface object moving into an upward curve may display changes consistent with changes in shape and/or speed to objects moving against gravity.

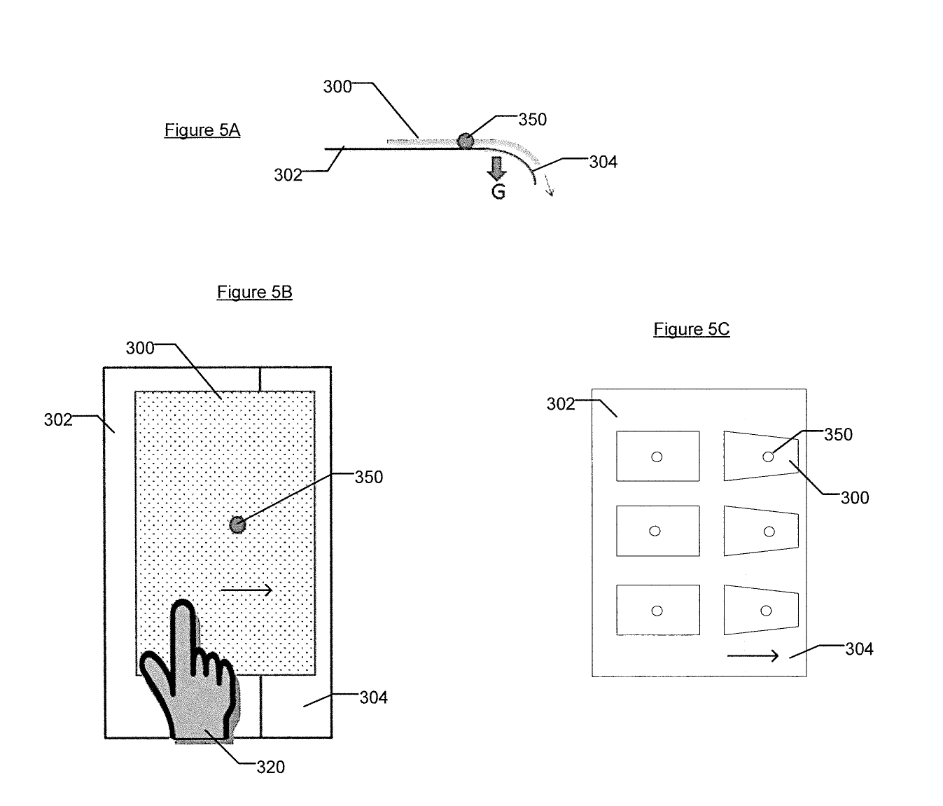

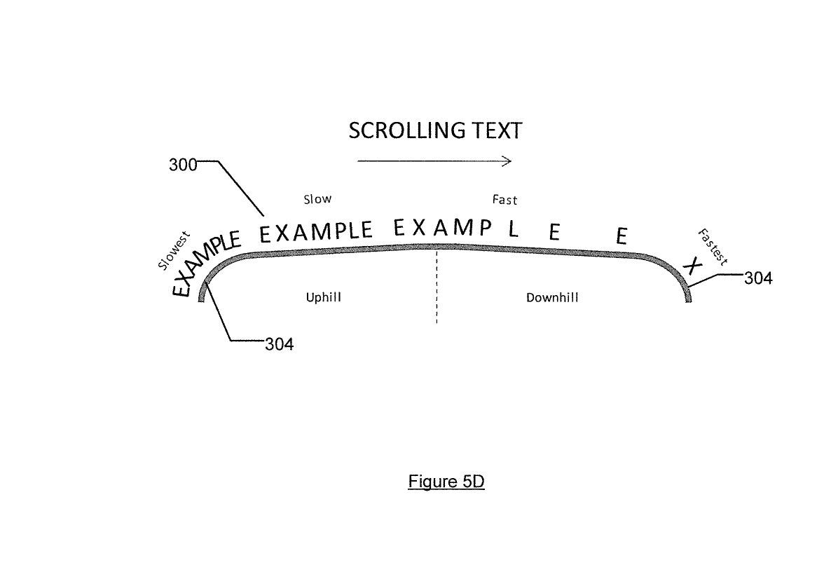

In the examples described above, a user interface object may be considered an object moving on some virtual environment illustrated on a curved display. Such embodiments may be useful in providing realistic screensavers, games, and/or the like. FIGS. 5A-5C illustrate example displays according to another example embodiment, where a user may navigate through thumbnails or other icons, representing files for example, on a display of user terminal 110. In FIG. 5A, which is a side view of an example display, a user interface object 300 having a hypothetical center of mass 350 is shown resting on the display for purpose of example. A portion of the user interface object 300 in the flat area 302 rests flat on the display. In curved area 304, the user interface object 300, subject to a gravitation effect, may be seen bending downward with the curve, similar to a photo falling from a table. In some embodiments, when the center of mass 350 reaches the curved area 304, the user interface object 300 may completely “slide” off the display. FIG. 5B offers a view looking down on the display, as a pointing device, or hand, 320 drags the user interface object 300 to the right and further out of the flat area 302 and into the downward curved area 304, having gravitational effects. FIG. 5C is an example display showing multiple user interface objects such as user interface object 300. By comparing various user interface objects on the display, a change in shape of user interface objects on the right side curved area can be seen relative to the user interface objects in the center, and flatter area of the display.

Another example embodiment is displayed in FIG. 5D, which is a side view of a curved display. A user could define a piece of text that is part of a screen saver and the text may move across the display, shown sitting upright for purpose of example. In this example embodiment, the letters are user interface objects 300. When a letter is in a curved area 304, the speed of the moving letters and/or spacing of letters may change. For example, as the letters move uphill, the letters may be close together and slow moving. In a downhill area, a letter may be detached from the rest of the text by “sliding” off the display at a relatively faster speed. The same idea could be used for example in a cycling game where the riders are closer together when riding uphill and with larger distances to each other when riding downhill.

In some example embodiments, any type of content, such as a web browser or other document, may display any of the gravitational effects provided by the gravitation effects apparatus 102 described herein. As described above, a user terminal 110 employing any of the gravitational effects may provide improved and/or realistic images to users. In some embodiments, different shapes of displays may be utilized. For example, on a semi-circle display, movement of a user interface object in any direct may be subject to a gravitation area. Additionally or alternatively, a user may define how the display feels/looks and how gravity affects the display. For example, a user could define that the display is “icy” and the acceleration and/or speed may change accordingly. In other words, a display may have different degrees of friction.

Additionally, pairing the gravitational effects with sound effects may make displayed content even more realistic to a user. In another example embodiment, the changing shape or speed of an object may warn a user that the object is about to fall outside the display area.

As described above, FIG. 2 illustrates a flowchart of operations performed by a gravitational effects apparatus 102. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 26 of a gravitational effects apparatus 102 employing an embodiment of the present invention and executed by a processor 20 of the gravitational effects apparatus 102. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included as indicated by the dashed outline of some operations in FIG. 2. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving an indication of a movement of a user interface object in a curved area of a display; and
causing the shape of the user interface object to change, with a processor, based on a position of the object in the curved area of the display.

2. A method according to claim 1, further comprising:
causing the speed of the user interface object to change based on the position of the object in the curved area of the display.

3. A method according to claim 1, wherein the user interface object displays an inertial property and a change to the user interface object is based on a virtual effect of gravity.

4. A method according to claim 1, wherein the user interface object is an object in a game.

5. A method according to claim 1, wherein the user interface object is an object on a screen saver.

6. A method according to claim 1, wherein the movement of the user interface object is caused by a user navigation.

7. A method according to claim 1, wherein a change to the user interface object is intensified as the user interface object moves into a more steeply curved area of the display, relative to a change of the user interface object in a flatter area of the display.

8. An apparatus comprising at least one processor and at least one memory including computer program code, the at least one memory and the computer program code configured to, with the processor, cause the apparatus to at least:
receive an indication of a movement of a user interface object in a curved area of a display; and
cause the shape of the user interface object to change based on a position of the object in the curved area of the display.

9. An apparatus according to claim 8, wherein the at least one memory and the computer program code are further configured to, with the processor, cause the apparatus to at least:
cause the speed of the user interface object to change based on the position of the object in the curved area of the display.

10. An apparatus according to claim 8, wherein the user interface object displays an inertial property and a change to the user interface object is based on a virtual effect of gravity.

11. An apparatus according to claim 8, wherein the user interface object is an object in a game.

12. An apparatus according to claim 8, wherein the user interface object is an object on a screen saver.

13. An apparatus according to claim 8, wherein the movement of the user interface object is caused by a user navigation.

14. An apparatus according to claim 8, wherein a change to the user interface object is intensified as the user interface object moves into a more steeply curved area of the display, relative to a change of the user interface object in a flatter area of the display.

15. A computer program product comprising at least one non-transitory computer-readable storage medium having computer-executable program code instructions stored therein, the computer-executable program code instructions comprising program code instructions to:
receive an indication of a movement of a user interface object in a curved area of a display; and
cause the shape of the user interface object to change based on a position of the object in the curved area of the display.

16. A computer program product according to claim 15, wherein the at least one memory and the computer program code are further configured to, with the processor, cause the apparatus to at least:
cause the speed of the user interface object to change based on the position of the object in the curved area of the display.

17. A computer program product according to claim 15, wherein the user interface object displays an inertial property and a change to the user interface object is based on a virtual effect of gravity.

18. A computer program product according to claim 15, wherein the user interface object is at least one of an object in a game or an object on a screen saver.

19. A computer program product according to claim 15, wherein the movement of the user interface object is caused by a user navigation.

20. A computer program product according to claim 15, wherein a change to the user interface object is intensified as the user interface object moves into a more steeply curved area of the display, relative to a change of the user interface object in a flatter area of the display.
